(19) United States
(12) Patent Application Publication
(10) Pub. No.: US 2026/0015903 A1
(43) Pub. Date: Jan. 15, 2026

(54) OPENING ASSEMBLY AND METHOD FOR RENOVATING THEREOF

(71) Applicant: GAL ROTLEVI, TEL AVIV (IL)

(72) Inventor: GAL ROTLEVI, TEL AVIV (IL)

(21) Appl. No.: 19/192,409

(22) Filed: Apr. 29, 2025

(30) Foreign Application Priority Data
Jul. 14, 2024 (IL) 314304

(51) Int. Cl. E06B 1/52

(52) U.S. Cl. CPC E06B 1/52

(57) ABSTRACT

A method for renovating an opening of a building, the method including the steps of, in a workshop, producing an adapter frame of the opening, in accordance with a lintel of the opening, producing a new opening assembly in accordance with the adapter frame, and in a site of the building, shipping the new opening assembly and the adapter frame from the workshop to the building site, removing an opening assembly from a wall thereof, except of a lintel thereof, installing the adapter frame into the lintel, and installing the new opening assembly into the lintel adapter frame. An opening assembly including an original lintel of the opening, an adapter frame, installed on the original lintel, and a renovated opening assembly, whose dimensions correspond to dimensions of the adapter frame.

### FIELD

The invention relates to the field of building opening preservation and renovation.

### BACKGROUND

The term “opening” refers herein to any space or gap in a building structure that allows access, light, or air to pass through.

The term, “lintel” refers herein to an entire frame of an opening (window, door, etc.) that connects an opening assembly to a wall opening.

The term “opening assembly” refers herein to the parts of a device placed in an opening of a building, including doors, windows, vents, and other similar architectural elements.

The term “workshop” refers herein to a site in which devices are manufactured or repaired.

When it comes to preserving historic or culturally significant buildings, opening renovation plays a crucial role. These renovations aim to maintain the building's original appearance while ensuring it meets modern building standards. Here are some key points:

Preserving Structural Integrity: During preservation, openings are carefully restored to maintain their stability. This involves repairing or replacing damaged frames, sashes, and hardware.

Upgrading Materials: Traditional materials like wood are often used to maintain the original look. However, modern options such as energy-efficient glass and weather-resistant coatings can enhance functionality.

Historical Accuracy: Preservationists strive to match the original design, including details like muntins (dividers within the glass) and profiles. Historical accuracy ensures continuity with the building's past.

Energy Efficiency: While preserving aesthetics, opening renovations also address energy efficiency. Double-glazed openings with low-emissivity coatings help reduce heat loss and improve insulation.

Skilled Craftsmanship: Restoration specialists, including carpenters and stone masons, play a vital role. Their expertise ensures that the renovated opening align with the building's original character.

Not only historic and old structures, but also the entrances of contemporary buildings might undergo renovations, for instance, because of substandard construction quality. Therefore, everything mentioned regarding the restoration of historic and aged buildings is equally applicable to the renovation work of any building.

In summary, opening renovation for preservation is a delicate balance between honoring history and meeting contemporary needs. As a result of the complexity, renovation work for preservation is expressed both in the working time, and in the need for professionals who specialize in renewal. Therefore, there is a long felt need for an effective solution to the problems of the prior art.

### SUMMARY

In one aspect, the invention is directed to a method for renovating an opening of a building, the method comprising the steps of, in a workshop, producing an adapter frame (12) of the opening, in accordance with a lintel (11) of the opening, producing a new opening assembly (100) in accordance with the adapter frame (12), and in a site of the building, shipping the new opening assembly and the adapter frame from the workshop to the building site, removing an opening assembly from a wall thereof, except of a lintel (11) thereof, installing the adapter frame (12) into the lintel (11), and installing the new opening assembly into the lintel adapter frame (12).

According to embodiments of the invention, an area where the opening assembly (100) meets the adapter frame (12) is tiered in both the opening assembly and the adapter frame, thereby allowing fitting the opening assembly (100) into the adapter frame (12).

According to embodiments of the invention, the lintel (11) is staired, and an area where the adapter frame (12) meets the lintel (11) is tiered in accordance with stairs of the lintel (11), thereby allowing fitting of the adapter frame (12) into the lintel (11).

According to embodiments of the invention, the opening assembly is a window. According to embodiments of the invention, the opening is of a door.

In another aspect, the invention is directed to an opening assembly, comprising an original lintel (11) of the opening, an adapter frame (12), installed on the original lintel (11), and a renovated opening assembly (100), whose dimensions correspond to dimensions of the adapter frame.

According to embodiments of the invention, an area where the opening assembly (100) meets the adapter frame (12) is tiered in both the opening assembly and the adapter frame, thereby allowing fitting the opening assembly (100) into the adapter frame (12).

According to embodiments of the invention, the lintel (11) is staired, and an area where the adapter frame (12) meets the lintel (11) is tiered in accordance with stairs of the lintel (11), thereby allowing fitting of the adapter frame (12) into the lintel (11).

According to embodiments of the invention, the opening assembly is of a window. According to embodiments of the invention, the opening assembly is of a door.

### BRIEF DESCRIPTION OF DRAWINGS

Embodiments, features, and aspects of the invention are described herein in conjunction with the following drawings, in which:

FIG. 1 pictorially illustrates a wall 15, in which is installed an opening assembly 100, according to the prior art;

FIG. 2 schematically illustrates a front view of a typical classic opening assembly, according to the prior art;

FIG. 3 schematically illustrates the cross-section A-A which is defined in FIG. 1;

FIG. 4 pictorially illustrates an opening space from which the opening assembly has been removed, and only the opening lintel 11 remains, according to embodiments of the invention;

FIG. 5 pictorially illustrates an opening space in which an adapter frame 12 has been installed;

FIG. 6 is a three-dimensional schematic illustration of an opening assembly in an open state, according to embodiments of the invention;

FIG. 7 shows the opening assembly, of FIG. 6, in an open state;

FIG. 8a is a cross-section of an opening assembly, according to the prior art;

FIG. 8b is a cross-section of an opening assembly, according to embodiments of the invention; and

Each of FIGS. 9a, 9b and 9c is a cross-section schematically illustrates two dimensional staired objects A and B meeting each other.

For the sake of clarity, some elements common in opening assemblies have been omitted.

It should be understood that the drawings are not necessarily drawn to scale.

### DETAILED DESCRIPTION

The invention will be understood from the following detailed description of embodiments which are meant to be descriptive and not limiting. For the sake of brevity, some well-known features, methods, systems, procedures, components, circuits, and so on, are not described in detail.

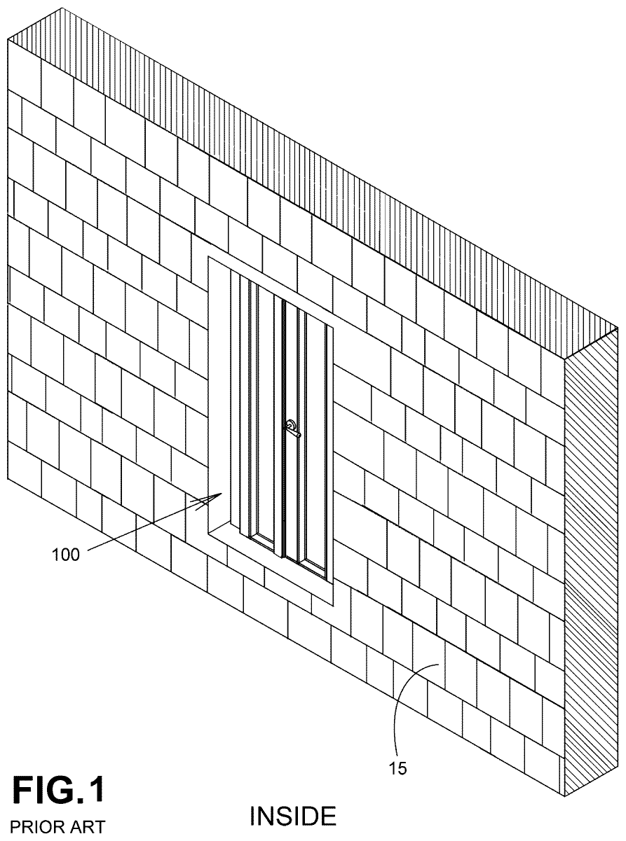

FIG. 1 pictorially illustrates a wall 15, in which is installed an opening assembly 100, according to the prior art.

In this example the opening is a window.

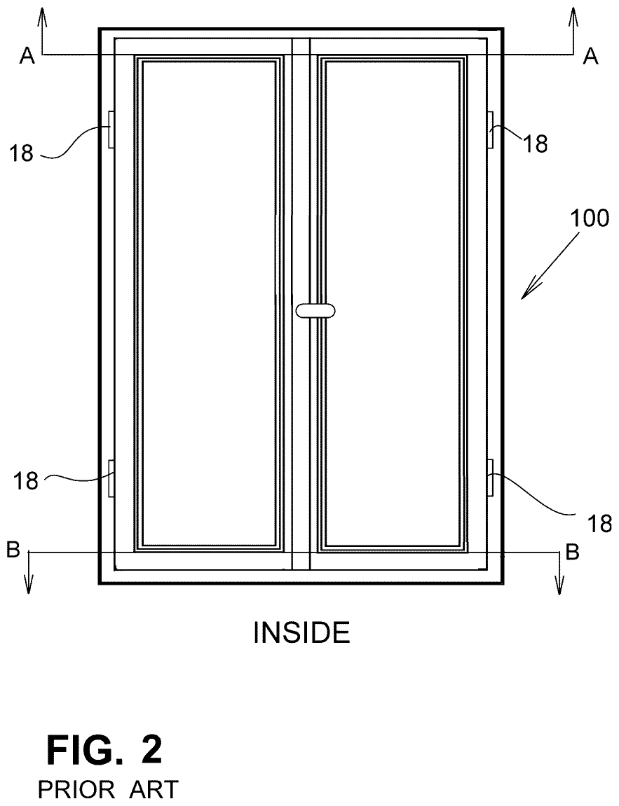

FIG. 2 schematically illustrates a front view of an opening assembly, according to the prior art.

The particular opening assembly if this figure comprises two opening segments, left and right segments. However, it should be noted that it is merely an example, and an opening may have one or more segments. Furthermore′ despite of the example refers to a window assembly, the same applies also for a door, and actually any type of opening assembly.

Reference numeral 18 denotes a hinge. In the prior art, the hinge is used for axially connecting the door assembly to the lintel of the opening.

In this figure are defined two horizontal cross-sections A-A, and B-B which apply for the prior art drawings and the invention drawings. The part of the opening assembly above cross-section A-A is removed, and so do the part under the cross-section B-B.

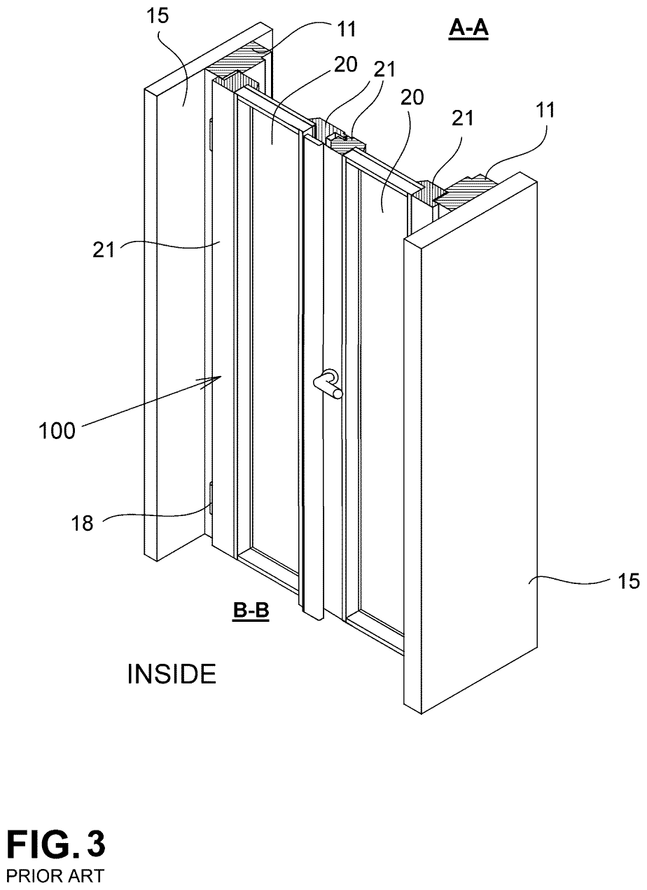

FIG. 3 schematically illustrates the cross-section A-A which is defined in FIG. 1.

It shows walls 15 of a building opening in which is installed an opening lintel 11. In the inner side of the lintel is installed an opening assembly 100. The opening assembly comprises two segments, left and right. Each of the opening segments comprises one or more glass boards 20, enclosed in a frame 21. The walls 15 are illustrated as boxes.

The opening assembly is axially connected via hinges 18 to the lintel 11.

Over time, the openings of a building wear out, and their renovation is required. Opening renovation requires is time consuming by skilled personnel in this particular craft, which means expensive work both in terms of cost and time.

The solution according to the invention is replacing the opening assemblies of a building with new opening assemblies that preserve the appearance of the building, in a simplified manner in comparison to the prior art, in a shorter time than in the prior art, and with less interference with the tenants' life than in the prior art.

In order to ease the renovation process, according to the invention only the opening assembly is replaced, while the opening lintel remains the original.

This way, all the opening assemblies are manufactured at the workshop, in an industrial manner, and only afterwards are installed at the building. In contrast, according to the prior art the entire renovation work is carried out at the building site, which means interfering to the building tenants' life, and longer working process.

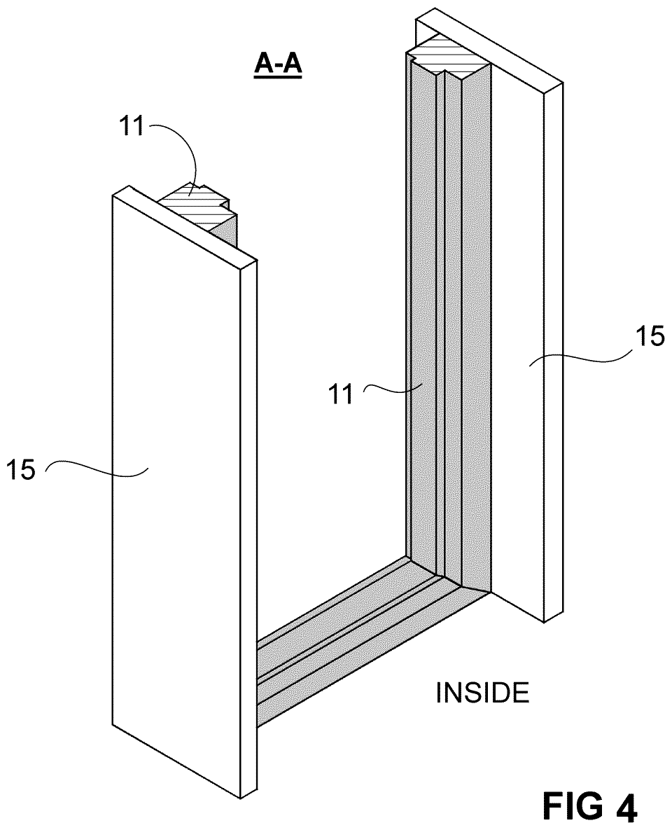

FIG. 4 pictorially illustrates an opening space from which the opening assembly has been removed, and only the opening lintel 11 remains, according to embodiments of the invention.

Thus, between walls 15 is installed an original lintel 11. The remaining components of the opening assembly have been removed.

This particular opening assembly refers to window, and therefore includes a lower bar; however when it comes to a door opening, the lower horizontal bar is usually missing.

This is a first stage in renovation of an opening, according to embodiments of the invention.

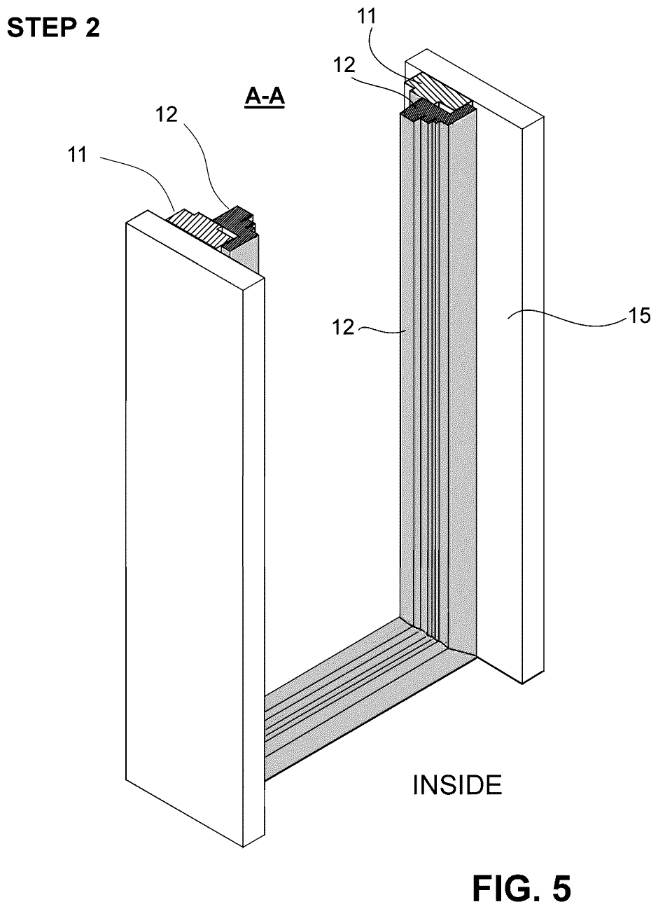

FIG. 5 pictorially illustrates an opening space in which an adapter frame 12 has been installed.

This is a second stage in renovation of an opening, according to embodiments of the invention.

On the interior side of the original lintel, an additional frame 12 (referred herein as “adapter frame”) is installed. The adapter frame 12 corresponds (i.e., has negative surface relief shape) to the original lintel 11 on one side thereof and corresponds to the new opening assembly on the other side thereof.

This approach allows the new opening assembly to be manufactured in a workshop equipped with all necessary facilities. Once ready, it can be transported to the building site and seamlessly installed “instantly” into the original lintel 11. Notably, no on-site storage space is required during this process.

Manufacturing the opening assemblies in a workshop results with industrialization of the renovation process, thereby enables a faster process than in the prior art, and as a result less manufacturing effort and cost.

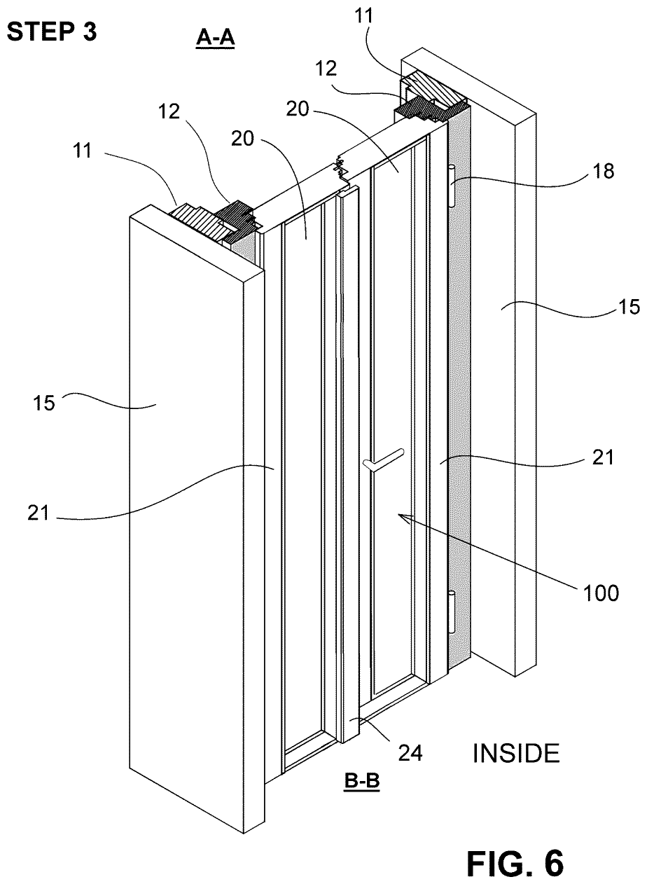

FIG. 6 pictorially illustrates an opening space in which a opening assembly 100 has been installed.

The installation is actually fixing the hinges 18 of the opening assembly 100 in the adapted frame 12.

This drawing further details the structure of an opening, assembly according to embodiments of the invention.

It shows, inter alia, the glass board 20, the glass frame 21, and the covering panel 24.

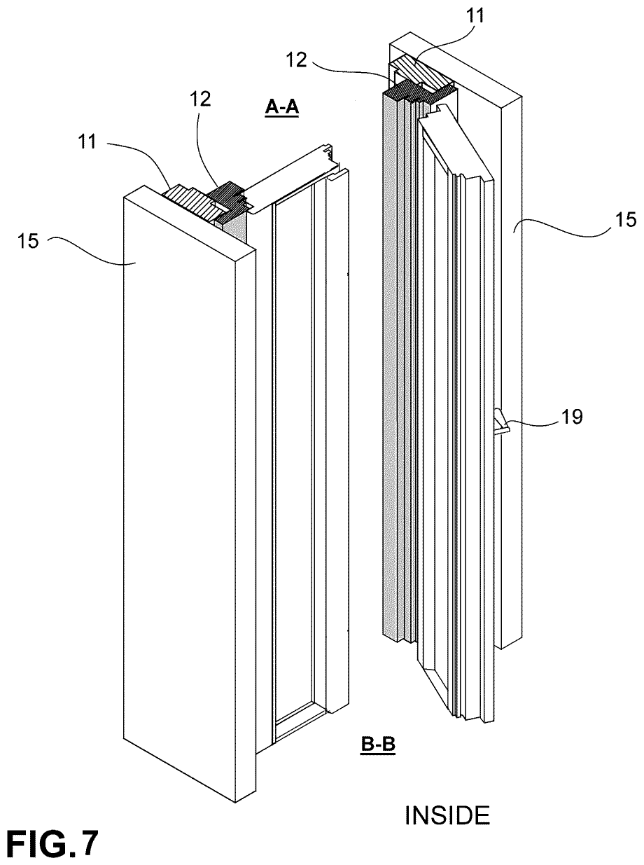

FIG. 7 shows the opening assembly, of FIG. 6, in an open state.

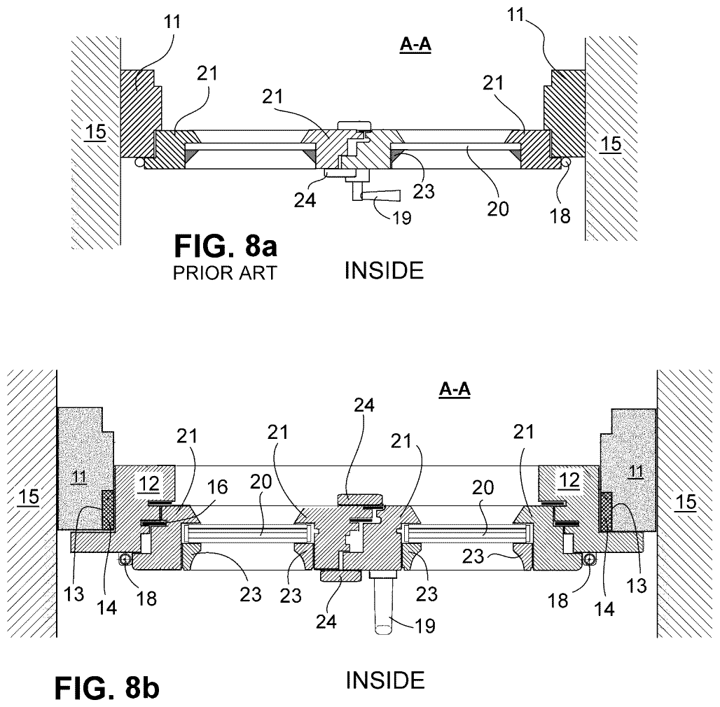

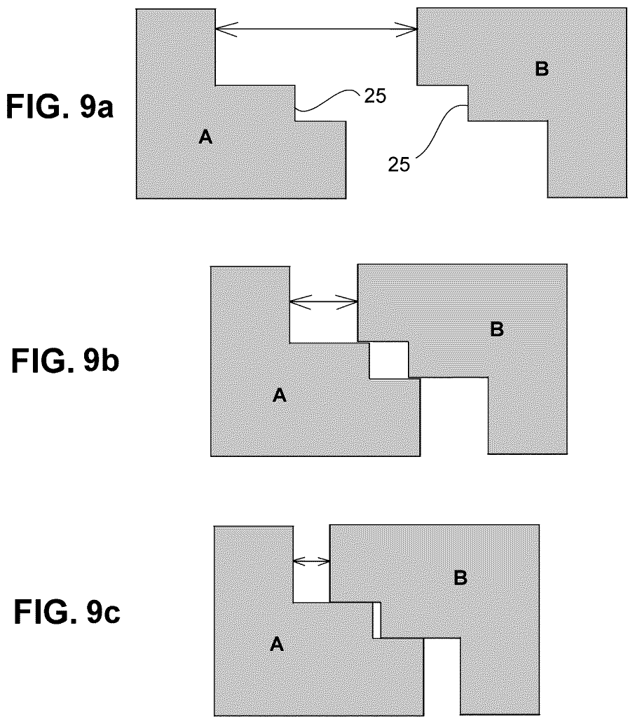

FIG. 8a is a cross-section of an opening assembly, according to the prior art.

FIG. 8b is a cross-section of an opening assembly, according to embodiments of the invention.

These figures allow to compare the invention vs. the prior art. As illustrated, the adapter frame 12 is not present in the prior art, i.e., is absent from FIG. 8a which illustrates the prior art.

Between the adapter frame 12 and the lintel 11 there is a space filled with sealing and/or adhesive material 13. The adhesive attaches the adapter frame 12 to the lintel 11.

Frames 23 fasten the glass board 20 to the glass frame 21. The frame 23 can be substituted with putty (“a doughlike material typically made of whiting and linseed oil that is used especially to fasten glass in opening frames and to fill crevices in woodwork”, Merriam Webster Dictionary).

Reference numeral 16 denotes a sealing strap. The sealing straps are required for heat and water isolation.

Reference numeral 19 denotes a handle used for locking an opening assembly. However, the specifics of opening locking are not elaborated here, as they do not form part of the invention.

Reference numeral 24 denotes a covering panel for covering the space between adjacent opening assemblies, in openings that comprise more than one segment.

### The Deformation Obstacle of Walls

One of the challenges encountered during renovation of old buildings arises from the fact that the walls of an aged building may be deformed slightly over time. Consequently, an opening space can vary from opening to opening. As a result, an opening crafted in a workshop may not precisely fit an opening space of a building.

Each of FIGS. 9a, 9b and 9c is a cross-section schematically illustrates two dimensional staired objects A and B meeting each other.

In FIG. 9a are illustrated two separate objects A and B having corresponding staired surfaces. In FIG. 9b the objects are close to each other. In FIG. 8c the objects are closer to each other than in FIG. 9b.

Returning to the previous drawings, the stairs of the objects provide a degree of freedom in placing the objects next to each other. As a result of this structure, although the adapter frames 12 is identical in all the openings of a wall of a building in a renovation process, the same adapter frame 12 suits for all the same kind of openings of a building.

In the figures and/or description herein, the following reference numerals (Reference Signs List) have been mentioned:
numeral 100 denotes an opening assembly, according to embodiments of the invention;
numeral 11 denotes an original opening lintel;
numeral 12 denotes an adapter frame;
numeral 13 denotes a sealing and/or adhesive material;
numeral 15 denotes a wall;
numeral 16 denotes a sealing strap;
numeral 18 denotes a hinge;
numeral 19 denotes a handle;
numeral 20 denotes a glass board;
numeral 21 denotes a glass frame;
numeral 23 denotes a frame or putty for fastening a glass board to the glass frame 21;
numeral 24 denotes a covering panel for a space generated between adjacent opening assemblies; and
numeral 25 denotes a staired surface.

The foregoing description and illustrations of the embodiments of the invention has been presented for the purposes of illustration. It is not intended to be exhaustive or to limit the invention to the above description in any form.

Any term that has been defined above and used in the claims should be interpreted according to this definition.

The reference numbers in the claims are not a part of the claims, but rather used for facilitating the reading thereof. These reference numbers should not be interpreted as limiting the claims in any form.

What is claimed is:

1. A method for renovating an opening of a building, the method comprising the steps of:
in a workshop:
producing an adapter frame (12) of said opening, in accordance with a lintel (11) of said opening;
producing a new opening assembly (100) in accordance with said adapter frame (12); and
in a site of said building:
shipping said new opening assembly and said adapter frame from said workshop to said building site;
removing an opening assembly from a wall thereof, except of a lintel (11) thereof;
installing said adapter frame (12) into said lintel (11); and
installing said new opening assembly into said adapter frame (12),
wherein an area where said opening assembly (100) meets said adapter frame (12) is tiered in both said opening assembly and said adapter frame, thereby allowing fitting said opening assembly (100) into said adapter frame (12), and
wherein said lintel (11) is staired, and an area where said adapter frame (12) meets said lintel (11) is tiered in accordance with stairs of said lintel (11), thereby allowing fitting said adapter frame (12) into said lintel (11) despite of movement of walls of said building over years.

2. An opening assembly, comprising:
an original lintel (11) of said opening;
an adapter frame (12), installed on said original lintel (11); and
a renovated opening assembly (100), whose dimensions correspond to dimensions of said adapter frame
wherein an area where said opening assembly (100) meets said adapter frame (12) is tiered in both said opening assembly and said adapter frame, thereby allowing fitting said opening assembly (100) into said adapter frame (12), and
wherein said lintel (11) is staired, and an area where said adapter frame (12) meets said lintel (11) is tiered in accordance with stairs of said lintel (11), thereby allowing fitting of said adapter frame (12) into said lintel (11) despite of movement of walls of said building over years.
